(19) United States
(12) Patent Application Publication
(10) Pub. No.: US 2015/0325135 A1
(43) Pub. Date: Nov. 12, 2015

(54) Reading Assistance Method

(71) Applicant: Donald Mangus, Chico, CA (US)

(72) Inventor: Donald Mangus, Chico, CA (US)

(21) Appl. No.: 14/699,544

(22) Filed: Apr. 29, 2015

Related U.S. Application Data
(60) Provisional application No. 61/990,870, filed on May 9, 2014.

(51) Int. Cl. G09B 17/02

(52) U.S. Cl. CPC G09B 17/02

(57) ABSTRACT

A reading assistance method for allowing a user to easily read consecutive lines of text in a book, newspaper, or other written material. The reading assistance method includes the step of providing a first indicia at the end of a first line of text. The second line of text, defined as the immediately following line of text, includes the first indicia at the beginning thereof, and includes the second indicia at the end thereof. The third line of text begins with the second indicia. Thus, upon reaching the end of a line of text, the user can visually identify the indicia at the end of the text and can begin reading the next line of text which includes the same indicia at the beginning thereof. In this way, the user can easily determine his or her place on a page while reading.

### CROSS REFERENCE TO RELATED APPLICATION

This application claims the benefit of U.S. Provisional Application No. 61/990,870 filed on May 9, 2014. The above identified patent application is herein incorporated by reference in its entirety to provide continuity of disclosure.

### BACKGROUND OF THE INVENTION

### Field of the Invention

The present invention relates to reading assistance methods. More specifically, the present invention provides a reading assistance method for allowing a user to easily locate the next line of text after reading a first line of text, helping to avoid the user losing his or her place on a page. The method involves including a first indicia at the end of a line of text and beginning the subsequent line of text with the same indicia so as to allow a user to easily proceed to the next line of text by noting the indicia. The indicia at the end of each line alternates between two or more indicia so that each line of text begins with a first indicia and ends with a second indicia. Thus, the method allows a user to more easily identify the subsequent line of text on a page of reading material upon reading a preceding line of text.

Generally, lines of text in reading material are read from left to right, and upon completion of one line of text, the person must mentally move down one line and start the next line at the left side of the page. As a result, it can be easy to accidentally read the wrong line of text after finishing reading a first line of text. The person may accidentally skip a line of text, or may resume reading the line of text that had just been read. This is particularly true for reading materials having large pages with small text. As a result, the user may spend extra time reading and re-reading a page, and the user may lose his or her place in the reading material.

Children who are learning to read often have difficulty moving from one line of text to the next. Similarly, people with visual disabilities may have difficulty reading consecutive lines of text without losing their place. Some people follow the lines of text with their finger in order to more easily identify the line of text that should be read. However, this can be inconvenient and people may desire a means for more easily determining the next line of text in reading material without having to follow along with their finger.

Devices have been disclosed in the prior art that relate to reading assistance devices. These include devices that have been patented and published in patent application publications. These devices generally relate to devices for isolating certain lines or words on a page. For example, U.S. Pat. No. 7,565,759 and U.S. Pat. No. 8,070,492 relate to devices for blocking out one or more lines of text on a page for isolating a single line or portion of the page to be read. Other patents relate to reading assistance devices for allowing a reader to break down and identify new words, such as U.S. Pat. No. 7,056,122. Further, some devices provide line indicator devices that can be placed over a page and that include movable guides for indicating the line of text, such as U.S. Pat. No. 2,699,748 and U.S. Pat. No. 890,438.

These prior art devices have several known drawbacks. The prior art devices relate to separate devices that must be placed on a page of reading material and that must be adjusted as the reader reads each line in order to assist the user in reading each line. Repeatedly moving and adjusting such a device can be time consuming and inconvenient. Further, such devices may not be suited for reading materials of various shapes and sizes, and the devices are hard to position on the page while simultaneously holding the book in an open configuration. Thus, the prior art devices fail to provide a means for allowing a user to easily determine his or her place on a page, wherein indicia or indicators are included at the beginning and end of each line of text in order to visually guide the user's eye to the next line of text.

In light of the devices disclosed in the prior art, it is submitted that the present invention substantially diverges in design elements from the prior art and consequently it is clear that there is a need in the art for an improvement to existing reading assistance methods. In this regard the instant invention substantially fulfills these needs.

### SUMMARY OF THE INVENTION

In view of the foregoing disadvantages inherent in the known types of reading assistance methods now present in the prior art, the present invention provides a new reading assistance method wherein the same can be utilized for providing convenience for the user when reading consecutive lines of text without losing his or her place.

It is therefore an object of the present invention to provide a new and improved reading assistance method that has all of the advantages of the prior art and none of the disadvantages.

It is another object of the present invention to provide a reading assistance method that includes the step of inserting a first indicia at the end of a first line of text and inserting the same indicia at the beginning of the subsequent line of text to allow a user to easily read consecutive lines of text.

Another object of the present invention is to provide a reading assistance method that includes using two or more indicia in alternating fashion so that the user can easily identify which line of text corresponds to the subsequent line.

Yet another object of the present invention is to provide a reading assistance method that utilizes different indicia, colors, or shapes at the beginning and end of multiple lines of text to assist the reader in reading consecutive lines of text.

A further object of the present invention is to provide a reading assistance method that prevents the user from losing his or her place on a page of text.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of an embodiment of a page of text that includes indicia thereon in accordance with the present invention.

FIG. 2 shows a view of an alternate embodiment of a page of text that includes indicia thereon in accordance with the present invention.

FIG. 3 shows a flowchart of the operation of the reading assistance method of the present invention.

### DETAILED DESCRIPTION OF THE INVENTION

Reference is made herein to the attached drawings. Like reference numerals are used throughout the drawings to depict like or similar elements of the reading assistance method. For the purposes of presenting a brief and clear description of the present invention, the preferred embodiment will be discussed as used for helping a user to easily move to the next line of text on a page of reading material without losing his or her place on the page. The figures are intended for representative purposes only and should not be considered to be limiting in any respect.

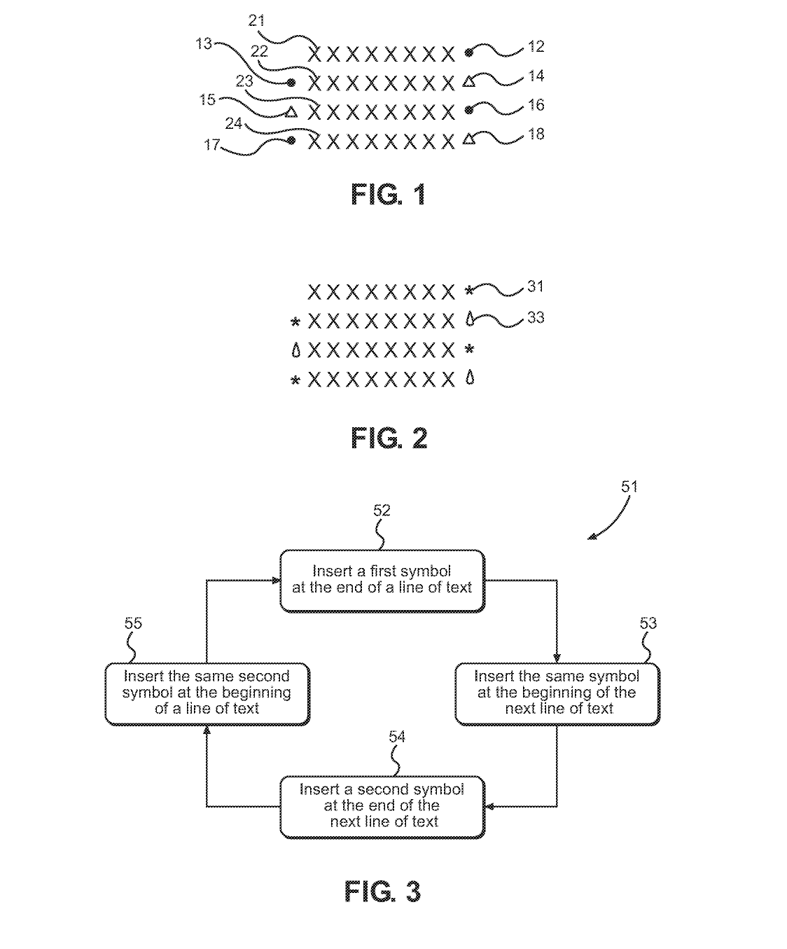

Referring now to FIGS. 1 and 2, there are shown views of embodiments of a page of text that includes indicia thereon. The reading assistance method includes the use of indicia at the beginning and end of lines of text on a page of reading material. A first instance of a first indicia 12 is printed at the end of a first line of text 21. The beginning of a second line of text 22, wherein the second line of text 22 is the line of text immediately following the first line of text, includes a second instance of the same first indicia 13. In this way, when the user has finished reading the first line of text 21, the user can note the indicia 12 at the end thereof, and can locate the same indicia 13 at the beginning of the second line of text 22. Thus, matching indicia are used in order to allow the user to easily identify the next line of text.

The second line of text 22 further comprises a first instance of a second indicia 14 at the end thereof. The second indicia 14 differs from the first indicia 12, 13 so that it is easily distinguished therefrom. The third line of text 23, wherein the third line of text 23 is the line of text immediately following the second line of text, includes a second instance of the second indicia 15 at the beginning thereof. Thus, the indicia 14 at the end of the second line of text 22 matches the indicia 15 at the beginning of the third line of text 23. Thus, the user can move from the second line of text 22 to the third line of text 23 by following the matching second indicia 14, 15.

The remaining lines of text on the page can be marked in the same fashion as described above. Thus, the third line of text 23 ends with another instance of the first indicia 16. Further, the fourth line of text 24 begins with the same first indicia 17 and ends with the second indicia 18. In this way, the first and second indicia form an alternating pattern in a vertical direction along the beginning of each line of text on a page. Similarly, the first and second indicia form an alternating pattern in a vertical direction along the end of each line of text on a page. If the user is reading the first line of text 21 he or she will not accidentally skip to the third line of text 23 as that line begins with the second indicia 15 as opposed to the first indicia 12.

In the illustrated embodiments, the reading assistance method is shown as using a first indicia and a second indicia in alternating fashion. However, in alternate embodiments three or more indicia may be used in the same manner. Thus, a first indicia will be used at the end of a line and the beginning of the subsequent line. A second indicia will be used at the end of a line and the beginning of a subsequent line. A third indicia will be used at the end of a line and the beginning of a subsequent line. Then, the first indicia will be repeated at the end of the line with the third indicia and the beginning of a subsequent line, etc. In this way, the user is less likely to skip to an incorrect line due to the variety of indicia shown on the page. Thus, a plurality of different indicia can be used in order to help the user read consecutive lines of text in the correct order without losing his or her place on the page.

The term “indicia” is intended to denote the use of any shape, color, symbol, or character. In FIG. 1, the first indicia 12 is shown as a colored circle, and the second indicia 14 is shown as an uncolored triangle. However, alternate shapes can be used such as squares, diamonds, hexagons, or any of various other shapes. Further, such shapes can be provided in any of various colors. Preferably, the first and second indicia different in shape or color, or both, in order to allow the user to more easily visually distinguish between the first and second indicia. In FIG. 2, the first indicia is shown as an asterisk 31 and the second indicia is shown as a rain drop 32. Thus, the indicia can also include any decorative shape or a character, such as an asterisk, a pound symbol, among other various symbols.

Referring now to FIG. 3, there is shown a flowchart of the operation of the reading assistance method of the present invention. The reading assistance method 51 allows a user to more easily read consecutive lines of text in the correct order, which may be particularly beneficial for the visually impaired and children learning to read. In operation, a first line of text is marked with a first indicia at the end thereof 52. The same first indicia is inserted at the beginning of the second line of text 53. Thus, the user can note the matching indicia in order to identify the correct line of text to read. A second indicia is marked at the end of the second line of text 54. The same indicia is inserted at the beginning of a third line of text 55. Then, the process repeats as the end of the third line of text is marked with the first indicia. Thus, the entire page of text can be marked in this fashion by alternating between the first and second indicia.

Thus, the present invention provides a reading assistance method that allows users to easily read consecutive lines of text on a page by helping to identify the next line of text to read upon completion of a line of text. Any of a variety of indicia can be used to mark the beginning and ends of the lines of text. The indicia can be small and simple in order to avoid detracting from or distracting the reader from the text. Alternatively, the indicia can be colorful and can comprise decorative shapes so as to make reading more fun or exciting for children learning to read.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A reading assistance method for reading consecutive lines of text, comprising the steps of:
providing a first instance of a first indicia at an end of a first line of text;
providing a second instance of said first indicia at a beginning of a second line of text.

2. The reading assistance method of claim 1, further comprising the steps of:
providing a first instance of a second indicia at the end of the second line of text;
providing a second instance of the second indicia at a beginning of a third line of text.

3. The reading assistance method of claim 2, wherein said first indicia is not the same as said second indicia.

4. The reading assistance method of claim 2, wherein said first indicia comprises a first color and wherein said second indicia comprises a second color.

5. The reading assistance method of claim 2, wherein said first indicia comprises a first shape, and said second indicia comprises a second shape.

6. The reading assistance method of claim 2, wherein said first indicia comprises a first character, and said second indicia comprises a second character.

7. The reading assistance method of claim 1, wherein a plurality of indicia are used.

8. The reading assistance method of claim 1, further comprising the step of:
repeating said first providing step and said second providing step for each line of text on a page.
